(19) United States
(12) Patent Application Publication
(10) Pub. No.: US 2026/0346609 A1
(43) Pub. Date: Nov. 5, 2026

(54) INKJET PRINTER AND METHOD FOR CLEANING HEAD UNIT

(71) Applicant: KYOCERA CORPORATION, Kyoto-shi, Kyoto (JP)

(72) Inventors: Hiroatsu TAMAI, Osaka-shi (JP); Tomoya HOTANI, Kimino-cho, Kaisou-gun, Wakayama (JP); Jumpei HOBO, Yamatokoriyama-shi, Nara (JP)

(21) Appl. No.: 19/488,067

(22) PCT Filed: Jun. 6, 2024
(86) PCT No.: PCT/JP2024/020698

§ 371 Date: Nov. 26, 2025

(30) Foreign Application Priority Data
Jun. 6, 2023 (JP) 2023-092878
Jan. 24, 2024 (WO) PCT/JP2024/002062

(51) Int. Cl. B41J 2/165; B41J 11/00; B41J 25/00

(52) U.S. Cl. CPC B41J 2/16535; B41J 2/16526; B41J 11/0015; B41J 25/005; B41J 2002/16573; B41P 2235/20

(57) ABSTRACT

An inkjet printer includes a treatment liquid head, an ink head, a first member, and a second member. The treatment liquid head ejects a treatment liquid. The ink head ejects ink. The first member cleans a nozzle placement surface of the treatment liquid head. The second member cleans a nozzle placement surface of the ink head. The second member is different from the first member in material, cleaning method, or characteristic.

### TECHNICAL FIELD

The present disclosure relates to an inkjet printer including a treatment liquid head to eject a treatment liquid and an ink head to eject ink, and a method for cleaning a head unit including the treatment liquid head and the ink head.

### BACKGROUND OF INVENTION

Inkjet printers include heads each including many nozzles that eject ink or predetermined treatment liquids. Such heads each have a nozzle placement surface to be cleaned at predetermined times to, for example, unclog the nozzles and remove contaminants on the nozzle placement surface.

Patent Literature 1 describes an inkjet printer that cleans a nozzle placement surface of a single head including treatment liquid ejection nozzles and ink ejection nozzles with a wiping member supported by a pressing member. Patent Literature 2 describes an inkjet printer that cleans a nozzle placement surface of a head with different wiping members, or a wiping blade that is a porous member and a wiping blade that is an elastic member.

### CITATION LIST

### Patent Literature

Patent Literature 1: Japanese Unexamined Patent Application Publication No. 2022-161141
Patent Literature 2: Japanese Unexamined Patent Application Publication No. 2016-32930

### SUMMARY

In one aspect of the present disclosure, an inkjet printer includes a treatment liquid head, an ink head, a first member, and a second member. The treatment liquid head ejects a treatment liquid. The ink head ejects ink. The first member cleans a nozzle placement surface of the treatment liquid head. The second member cleans a nozzle placement surface of the ink head. The second member is different from the first member in structure, material, cleaning method, or characteristic.

In another aspect of the present disclosure, a method is for cleaning a head unit including a treatment liquid head for ejecting a treatment liquid and an ink head for ejecting ink. The method includes cleaning a nozzle placement surface of the treatment liquid head with a first member, and cleaning a nozzle placement surface of the ink head with a second member. The second member is different from the first member in structure, material, cleaning method, or characteristic.

### BRIEF DESCRIPTION OF THE DRAWINGS

FIG. 1 is a front view of an inkjet printer according to one embodiment of the present disclosure, illustrating its overall structure.

FIG. 2 is a cross-sectional view taken along line II-II in FIG. 1, additionally illustrating a printer.

FIG. 3 is an enlarged perspective view of a carriage illustrated in FIG. 1.

FIG. 4 is a perspective view of a blade wipe device (first device) included in the printer for cleaning treatment liquid heads and ink heads.

FIG. 5 is a plan view of a blade wiper and heads mounted on the carriage, illustrating the blade wiper above and the heads below.

FIG. 6 is a perspective view of an ink blade included in the blade wiper.

FIG. 7 is a schematic cross-sectional view of the carriage and the blade wiper.

FIG. 8 is a perspective view of a fabric wipe device (second device) included in the printer for cleaning the ink heads, illustrating nozzle placement surfaces being cleaned.

FIG. 9A is a left side view of the fabric wipe device.

FIG. 9B is a side view of a mover.

FIG. 10 is a perspective view of a fabric wiper.

FIG. 11 is a left side view of the fabric wipe device, with the fabric wiper in a cleaning orientation.

FIG. 12 is a block diagram of the inkjet printer partially illustrating its control configuration.

FIG. 13 is a flowchart of an example operation of cleaning the ink heads and the treatment liquid heads in the inkjet printer.

FIG. 14A is a diagram illustrating a cleaning procedure performed by the blade wiper to clean the ink heads.

FIG. 14B is a diagram illustrating the cleaning procedure performed by the blade wiper to clean the ink heads.

FIG. 14C is a diagram illustrating the cleaning procedure performed by the blade wiper to clean the ink heads.

FIG. 15 is a flowchart of another example operation of cleaning the ink heads and the treatment liquid heads.

FIG. 16 is a front view of an inkjet printer according to a variation of the embodiment, illustrating its overall structure.

### DESCRIPTION OF EMBODIMENTS

One embodiment of the present disclosure will now be described with reference to the drawings. In the present embodiment, an inkjet printer according to one or more embodiments of the present disclosure is, for example, a printer including ink heads that eject ink for image formation on a wide and elongated recording medium. In the example described below, a method for cleaning a head unit according to one or more embodiments of the present disclosure is applicable to a head unit included in the printer. In the present embodiment, the inkjet printer may be used for digital textile printing to print images such as letters or patterns on a recording medium (workpiece) including a textile such as woven fabric or knitted fabric by inkjet printing. In one or more embodiments of the present disclosure, the inkjet printer and the cleaning method are also used for printing various inkjet images on a recording medium such as a paper sheet or a resin sheet.

### Overall Structure of Inkjet Printer

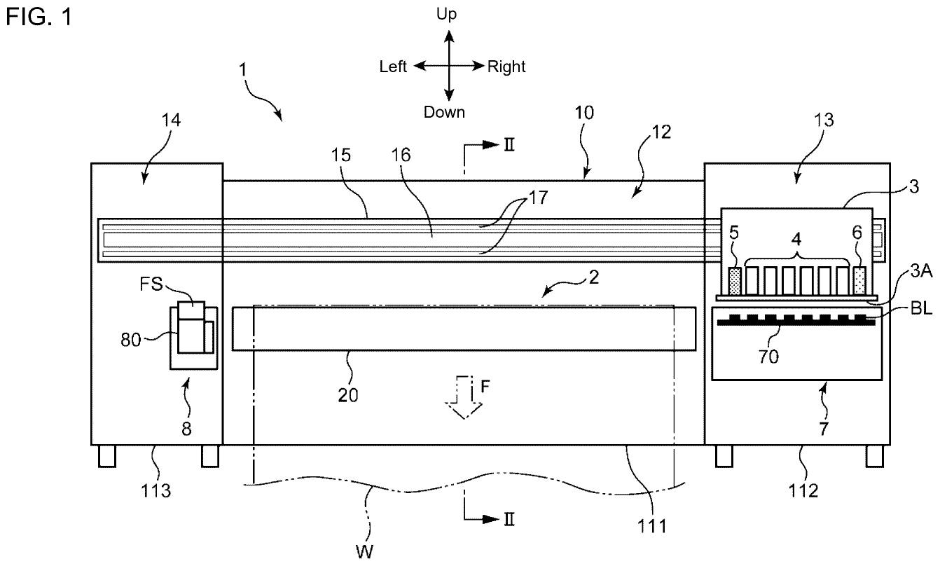

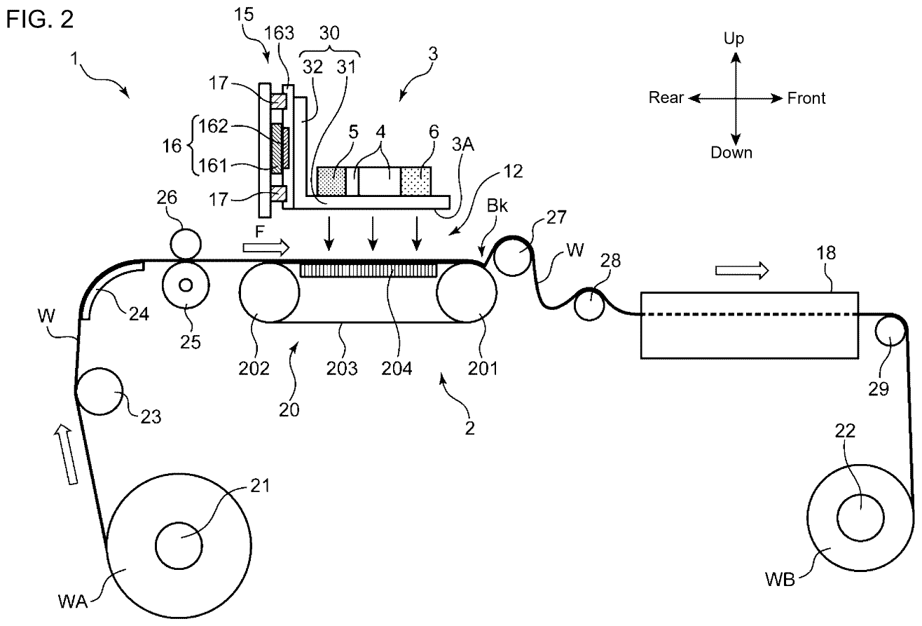

The overall structure of an inkjet printer 1 according to one embodiment of the present disclosure will be described first. FIG. 1 is a front view of the inkjet printer 1 according to the embodiment, illustrating its overall structure. FIG. 2 is a schematic cross-sectional view taken along line II-II in FIG. 1. Although FIGS. 1 and 2 and the figures referred to later include marks for indicating upper, lower, front, rear, left, and right directions, the marks are merely used for ease of explanation and do not limit directions.

The inkjet printer 1 prints images on a wide and elongated workpiece W by inkjet printing. The inkjet printer 1 includes an apparatus frame 10, a workpiece feeder 2 and a carriage 3 incorporated in the apparatus frame 10, and a dryer 19 located in front of the apparatus frame 10. Note that the dryer 19 is not illustrated in FIG. 1. In the present embodiment, a lateral direction is a main scanning direction in printing on the workpiece W, and a direction from rear to front is a subscanning direction, which is a transport direction F of the workpiece W.

The apparatus frame 10 is a frame on which various components of the inkjet printer 1 are mounted. The workpiece feeder 2 is an assembly that intermittently feeds the workpiece W to allow the workpiece W to move in the transport direction F from rear to front in a printing area in which an inkjet printing process is performed. The carriage 3 receives ink heads 4, a pretreatment head 5, a post-treatment head 6, and subtanks (not illustrated). The carriage 3 reciprocates in the lateral direction in the inkjet printing process.

The apparatus frame 10 includes a center frame 111, a right frame 112, and a left frame 113. The center frame 111 is a frame on which various components of the inkjet printer 1 are mounted. The center frame 111 has a lateral width corresponding to the workpiece feeder 2. The right frame 112 stands on the right of the center frame 111, and the left frame 113 stands on the left of the center frame 111. A printing area 12 in which a printing process is performed on the workpiece W extends between the right frame 112 and the left frame 113.

The printing area 12 is an area in which the carriage 3 reciprocates in a width direction perpendicular to the transport direction F of the workpiece W, or in other words, in the main scanning direction.

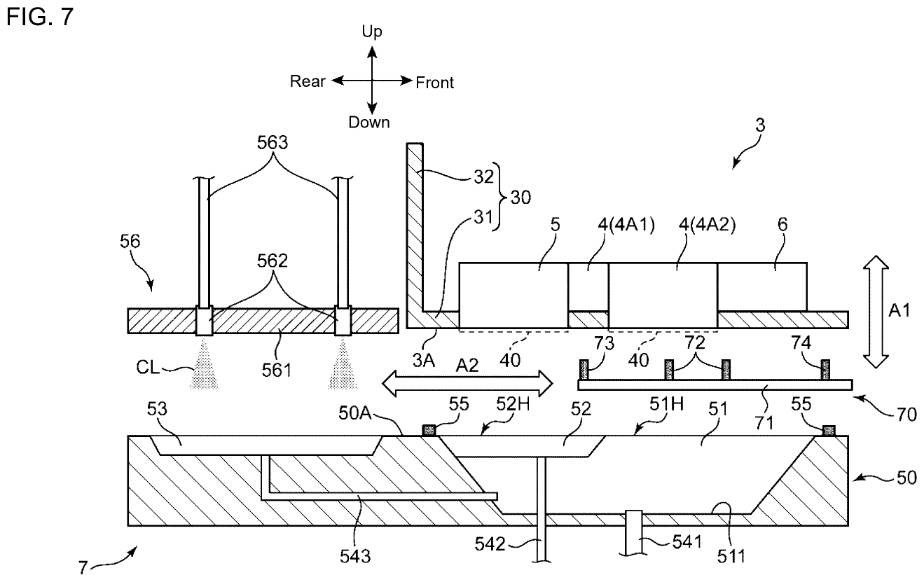

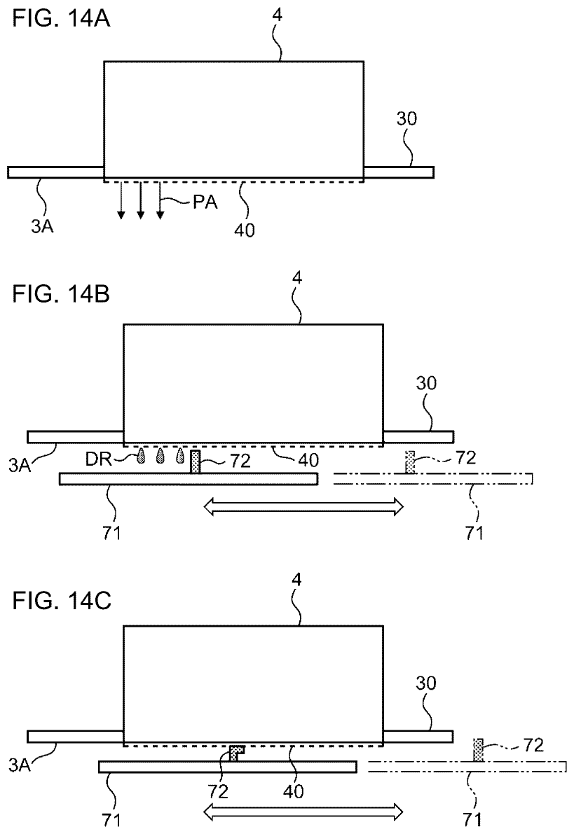

The right frame 112 defines a blade wipe area 13. The blade wipe area 13 is also an area into which the carriage 3 is retracted when the printing process is not performed. In this area, the heads 4, 5, and 6 are purged, and nozzle placement surfaces 40 (FIGS. 7 and 14A to 14C) of the heads 4, 5, and 6 exposed on a lower surface 3A of the carriage 3 are cleaned with a blade at an appropriate time for maintenance. In the blade wipe area 13, a blade wipe device 7 (first device) that performs the blade cleaning is located. The blade wipe device 7 includes a blade wiper 70 including a blade BL (first member) to wipe the nozzle placement surfaces 40. The lower surface 3A of the carriage 3 and the nozzle placement surfaces 40 are physically wiped with the blade BL. The purging is a process of forcibly ejecting ink or treatment liquids from nozzles of the ink heads 4, the pretreatment head 5, and the post-treatment head 6 to, for example, remove air bubbles in the heads. The blade cleaning is a process of wiping the nozzle placement surfaces 40 of the heads 4, 5, and 6 with the blade BL. The blade wipe device 7 also serves as a cap to reduce drying of the heads 4, 5, and 6 not in operation.

The left frame 113 defines a fabric wipe area 14. The fabric wipe area 14 is an area in which fabric-wipe cleaning is performed to clean the nozzle placement surfaces 40 with a fabric sheet. In the fabric wipe area 14, a fabric wipe device 8 (second device) that performs fabric-wipe cleaning is located. The fabric wipe device 8 includes a fabric wiper 80 including a fabric sheet FS (second member). Note that the fabric wipe area 14 is also an area in which the carriage 3 turns backward. The carriage 3 that has scanned the printing area 12 from right to left in the printing process temporarily enters the fabric wipe area 14 before performing scanning in a reverse direction. During maintenance, the carriage 3 stops in the fabric wipe area 14, and the fabric wipe device 8 performs fabric-wipe cleaning. The fabric wipe device 8 is relatively small with respect to the fabric wipe area 14. When the carriage 3 moves in the fabric wipe area 14, the lower surface 3A of the carriage 3 (nozzle placement surfaces 40) is visible. This improves the maintainability of the inkjet printer.

In the present embodiment, as described above, the inkjet printer 1 includes two different types of wiping members, or the blade BL and the fabric sheet FS. This structure allows each of the nozzle placement surfaces to be cleaned in a manner appropriate for the corresponding one of the different types of heads, or the ink heads 4, the pretreatment head 5, and the post-treatment head 6, or in other words, in a manner appropriate for the characteristics of the liquid ejected from each of the heads. The blade BL cleans at least the pretreatment head 5 and the post-treatment head 6. The fabric sheet FS cleans the ink heads 4 alone. In the present embodiment, the blade BL cleans all the heads 4, 5, and 6. These will be described in detail later. An example of “cleaning” described below is “wiping.” However, “cleaning” is not limited to “wiping.” Note that a head having ejection highly affected by drying of the liquid that sticks or thickens can be cleaned with a member that achieves higher cleaning efficiency. For example, the ink heads 4, the pretreatment head 5, and the post-treatment head 6 having ejection affected by a greater degree in this order may be cleaned with members having correspondingly higher cleaning efficiency.

The blade wipe device 7 is in the blade wipe area 13 located in a right portion (one side portion) of the printing area 12, and the fabric wipe device 8 is in the fabric wipe area 14 located in a left portion (another side portion) of the printing area 12. The blade wipe area 13 and the fabric wipe area 14 are spaces inherent to the printer 1 as spaces for the carriage 3 reciprocating in the printing area 12 to retract and turn backward. These spaces are used to receive the blade wipe device 7 and the fabric wipe device 8. Thus, the printer 1 including two different wiping members is less likely to be larger.

The apparatus frame 10 receives, near its upper portion, a single-axis robot 15 for causing the carriage 3 to reciprocate in the lateral direction, or more specifically, in the main scanning direction, in the printing process. The single-axis robot 15 extends in the lateral direction above the workpiece feeder 2. The single-axis robot 15 includes a linear motor 16 and a pair of upper and lower guide rails 17. As illustrated in FIG. 2, the linear motor 16 includes a stator 161 located in a direction in which the single-axis robot 15 extends and a rotor 162 movable along the guide rails 17. The pair of guide rails 17 extend parallel to each Other in the lateral direction. The pair of guide rails 17 are engaged with a movable block 163 on which the rotor 162 is mounted. The carriage 3 is mounted on the movable block 163 and moved by the single-axis robot 15 to the left or right.

The workpiece feeder 2 includes a feed roller 21 that unwinds the unprinted workpiece W in the transport direction F, a winding roller 22 that winds the printed workpiece W, and a transport unit 20 located in the printing area 12. The feed roller 21 is a winding shaft of a feed roll WA as a wound roll of the unprinted workpiece W. The winding roller 22 is a winding shaft of a winding roll WB as a wound roll of the printed workpiece W. The feed roller 21 is located upstream from the printing area 12, and the winding roller 22 is located downstream from the dryer 19.

A path extending through the printing area 12 between the feed roller 21 and the winding roller 22 is a feed path of the workpiece W. The feed path includes, in the order from upstream, a tension roller 23, a workpiece guide 24, a transport roller 25, a pinch roller 26, the transport unit 20, a releasing roller 27, a loading roller 28, the dryer 19, and a turn roller 29.

The tension roller 23 applies a predetermined tension to the workpiece W upstream from the transport roller 25. The workpiece guide 24 changes the transport direction F of the workpiece W from upward to frontward and feeds the workpiece W into the printing area 12. The transport roller 25 generates a feed force for feeding the workpiece W intermittently in the printing area 12. The pinch roller 26 forms a feed nip with the transport roller 25. The transport roller 25 and the pinch roller 26 as a pair unwind the workpiece W from the feed roll WA, intermittently feeding the workpiece W in the transport direction F to pass through the printing area 12.

The transport unit 20 is located to stably feed the workpiece W through the printing area 12 without a rise or wobbles. The transport unit 20 includes a drive roller 201 and a follower roller 202 spaced from each other in a front-rear direction, and a conveyor belt 203 extending over the rollers 201 and 202. The workpiece W is fed in the transport direction F while being in close contact with a front surface of the conveyor belt 203. A platen 204 is located between the rollers 201 and 202 on a back surface of the conveyor belt 203. In the printing area 12, ink and treatment liquids are ejected from the ink heads 4, the pretreatment head 5, and the post-treatment head 6 to the workpiece W.

The releasing roller 27 is located obliquely in front of the drive roller 201 to release the printed workpiece W in close contact with the front surface of the conveyor belt 203 from the front surface. The workpiece W is released from the conveyor belt 203 at a releasing point Bk, at which the workpiece W is bent at a predetermined release angle. The workpiece W is then fed to the loading roller 28 downstream. The workpiece W is slack between the releasing roller 27 and the loading roller 28. The printed workpiece W is fed from the loading roller 28 to the dryer 19. The dryer 19 blows, for example, warm air to the wet workpiece W for drying. The turn roller 29 changes the transport direction F of the dried workpiece W from frontward to downward to guide the workpiece W to the winding roller 22.

The carriage 3 reciprocates, while being supported by the movable block 163 in a cantilevered manner, in the main scanning direction (lateral direction) intersecting with the transport direction F. The carriage 3 includes a carriage frame 30 on which the ink heads 4, the pretreatment head 5, the post-treatment head 6, and the subtanks (not illustrated) are mounted. The carriage frame 30 includes a head support frame 31 and a back frame 32. The head support frame 31 is a horizontal plate holding the heads 4, 5, and 6 described above. The back frame 32 is a vertical plate extending upward from a rear edge of the head support frame 31. The back frame 32 is fixed to the movable block 163.

### Details of Carriage

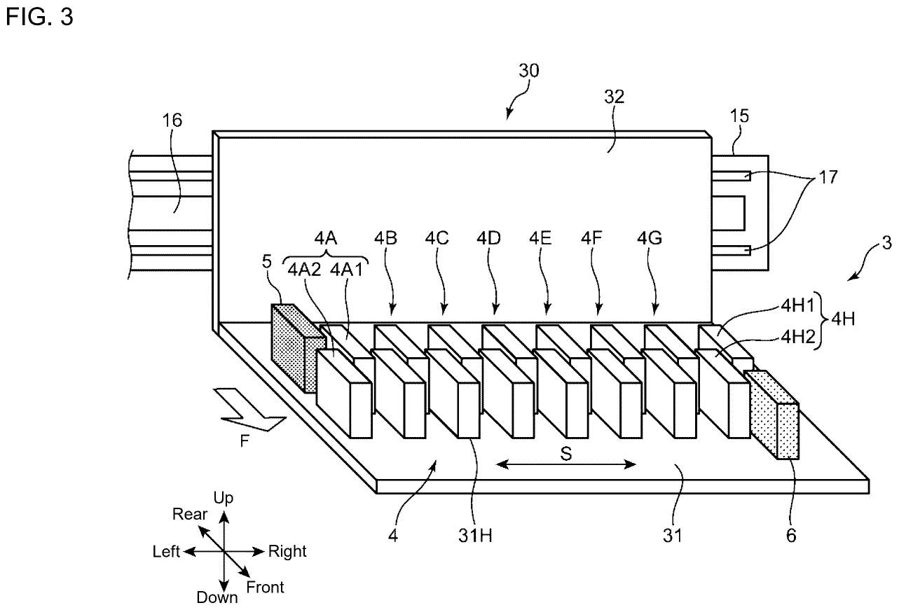

The carriage 3 will be described further. FIG. 3 is an enlarged perspective view of the carriage 3 illustrated in FIG. 1. In FIG. 3, the transport direction F (subscanning direction) of the workpiece W and the main scanning direction S in which the carriage 3 moves are illustrated. In the example illustrated in FIG. 3, the carriage 3 carries multiple ink heads 4 that eject ink for image formation onto the workpiece W, and the pretreatment head 5 and the post-treatment head 6 that eject noncolor-developing treatment liquids. More specifically, the carriage 3 in the present embodiment is a head unit including the ink heads 4 and the treatment heads 5 and 6. The actual carriage 3 also includes multiple subtanks for supplying the ink and the treatment liquids to the heads 4, 5, and 6. Note that the ink heads 4 briefly illustrated in FIG. 1 are illustrated more specifically in FIG. 3.

Each of the ink heads 4 includes many nozzles and an ink channel that guides ink to the nozzles. The nozzles eject ink droplets by, for example, piezoelectric ejection using piezoelectric elements or thermal ejection using heating elements. The same or a similar structure applies to the pretreatment head 5 and the post-treatment head 6. Examples of the ink include water-based pigment ink containing a water-based solvent, a pigment, and a binder resin. In the present embodiment, the multiple ink heads 4 include first to eighth ink heads 4A to 4H that eject eight different colors of ink.

The ink heads 4A to 4H for different colors are arranged on the head support frame 31 in the carriage 3 in the main scanning direction S. Each of the ink heads 4A to 4H for different colors includes two heads. For example, the first ink head 4A includes an upstream head 4A1 located upstream in the transport direction F and a downstream head 4A2 located downstream from the upstream head 4A1 and shifted leftward in the main scanning direction S. The same or a similar structure applies to the ink heads 4B to 4H for other colors. The upstream heads of the ink heads 4B to 4H are aligned with the upstream head 4A1 in the main scanning direction S at the same position in the transport direction F. The downstream heads in the ink heads 4B to 4H are aligned with the downstream head 4A2 in the main scanning direction S at the same position in the transport direction F.

The pretreatment head 5 and the post-treatment head 6 are at positions different from the positions of the ink heads 4 in the transport direction F. The pretreatment head 5 is located upstream from the ink heads 4 in the transport direction F. In the example illustrated in FIG. 3, one pretreatment head 5 is located near the left end of an array of the ink heads 4.

The pretreatment head 5 is on the left of the upstream head 4A1 in the first ink head 4A, behind the downstream head 4A2, and at the same position as the downstream head 4A2 in the main scanning direction S. In contrast, the post-treatment head 6 is located downstream from the ink heads 4 in the transport direction F. In the example illustrated in FIG. 3, one post-treatment head 6 is located near the right end of the array of the ink heads 4. The post-treatment head 6 is on the right of a downstream head 4H2 in the eighth ink head 4H, in front of an upstream head 4H1, and at the same position as the upstream head 4H1 in the main scanning direction S.

The pretreatment head 5 ejects a pretreatment liquid for a predetermined pretreatment of the workpiece W. The pretreatment liquid is ejected from the pretreatment head 5 to an area of the workpiece W on which no ink has been ejected from the ink heads 4. The pretreatment liquid is a noncolor-developing treatment liquid that develops no color on the workpiece W, and improves, for example, fixation of ink on the workpiece W or facilitates aggregation of ink pigments. Examples of the pretreatment liquid include a treatment liquid of a solvent containing a positively charged cationic resin.

The post-treatment head 6 ejects a post-treatment liquid for a predetermined post-treatment of the workpiece W on which ink is deposited. The post-treatment liquid is ejected from the post-treatment head 6 to an area of the workpiece W on which ink has been ejected from the ink heads 4. The post-treatment liquid is also a noncolor-developing treatment liquid that develops no color on the workpiece W. The post-treatment liquid improves the fixation and the fastness, such as durability against rubbing or scratching, of an ink image printed on the workpiece W by the ink heads 4. Examples of the post-treatment liquid include a silicone treatment liquid. As described above, the post-treatment head 6 and the pretreatment head 5 eject different liquids. The nozzle placement surfaces 40 of the post-treatment head 6 and the pretreatment head 5 may thus be cleaned with different members.

The head support frame 31 includes openings 31H at positions of the heads. The head support frame 31 receives the ink heads 4A to 4F, the pretreatment head 5, and the post-treatment head 6 fitted into the respective openings 31H. The nozzle placement surface 40 on the lower end face of each of the heads 4, 5, and 6 is exposed through the corresponding opening 31H.

In the present embodiment, as described above, the inkjet printer 1 is an all-in-one printer including three types of heads, or the ink heads 4, the pretreatment head 5, and the post-treatment head 6, mounted on the single carriage 3. The printer 1 can integrally perform the pretreatment liquid ejection and the post-treatment liquid ejection in an inkjet printing process on a textile in, for example, digital textile printing. This can simplify the textile printing process and reduce the size of textile printing apparatuses.

Head Maintenance As described above, the inkjet printer 1 includes the blade wipe device 7 and the fabric wipe device 8 for maintenance of the heads 4, 5, and 6. The blade wipe device 7 cleans the nozzle placement surfaces 40 (refer to FIG. 7) using the blade BL. The fabric wipe device 8 cleans the nozzle placement surfaces 40 using the fabric sheet FS. Note that the nozzle placement surfaces 40 are surfaces of the heads 4, 5, and 6 on which many nozzle openings for ejecting ink or the treatment liquids are arranged in a predetermined pattern. The nozzle placement surfaces 40 are exposed on the lower surface 3A of the carriage 3. In the example described above, the ink differs from the pretreatment liquid and the post-treatment liquid in that the ink contains a binder resin. More specifically, the ink contains a pigment corresponding to the expressed color and a binder resin that binds the pigment. In contrast, the pretreatment liquid and the post-treatment liquid do not contain a pigment and may or may not contain a binder resin. The ink containing a pigment and a binder resin has liquid properties different from those of the pretreatment liquid and the post-treatment liquid. The blade wipe device 7 and the fabric wipe device 8 are selectively used as appropriate based on the difference in the properties to clean the heads 4, 5, and 6.

The blade wipe device 7 performs blade cleaning regularly based on, for example, the print time, the printed area size, and the operating days. For the blade cleaning, the single-axis robot 15 moves the carriage 3 to the blade wipe area 13. Before the blade cleaning, the ink heads 4, the pretreatment head 5, and the post-treatment head 6 are purged to forcibly eject ink or the treatment liquids. After the purging, the blade wipe device 7 performs a contactless wipe (first cleaning) to wipe droplets dripping from the nozzle placement surfaces 40 of the heads 4, 5, and 6 with the blade BL and a contact wipe (second cleaning) to wipe the nozzle placement surfaces 40 with the cleaning blade in contact with the nozzle placement surfaces 40. Note that, in the present embodiment, the second wipe is different from the first wipe in that the second wipe allows contact with a wiped portion. The contact wipe and the contactless wipe will be described in detail with reference to FIGS. 14A to 14C.

After the blade cleaning described above, the fabric wipe device 8 performs fabric-wipe cleaning on the ink heads 4 alone. More specifically, although the pretreatment head 5 and the post-treatment head 6 are wiped with the blade BL alone, the ink heads 4 are wiped in two stages with the blade BL and then further with the fabric sheet FS. The fabric-wipe cleaning is performed on the ink heads 4 alone because the ink heads 4 eject liquids (ink) containing a pigment and a binder resin. Such liquids remaining on the nozzle placement surfaces may not be cleaned sufficiently by the blade cleaning alone. Each of the nozzles in the ink heads 4 is to have a predetermined meniscus at its nozzle opening for accurate ink jetting or dot formation. When the nozzle is clogged and undergoes the purging and the blade cleaning, the nozzle is less likely to have an expected meniscus at its nozzle opening. Wiping the nozzle placement surfaces with the fabric sheet FS after blade cleaning allows the nozzle opening to have an appropriate meniscus. However, wiping with the fabric sheet FS directly after purging causes the fabric sheet FS to excessively absorb droplets and immediately become nonfunctional for cleaning. Thus, wiping with the blade BL is performed first.

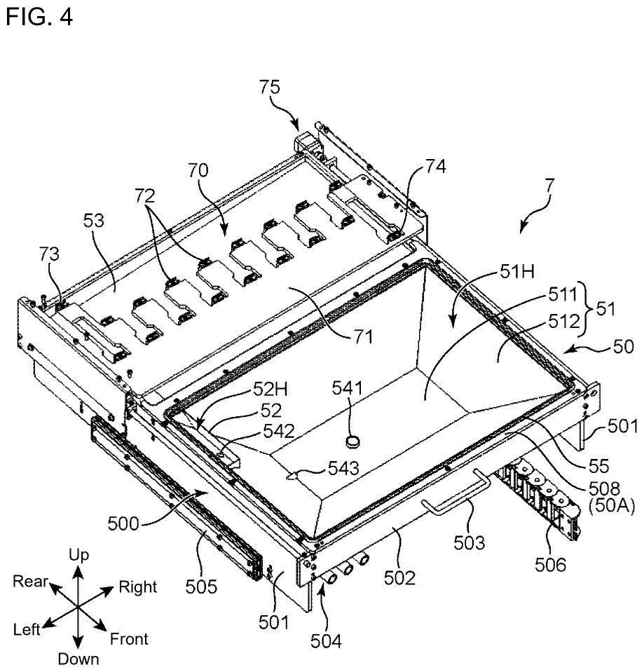

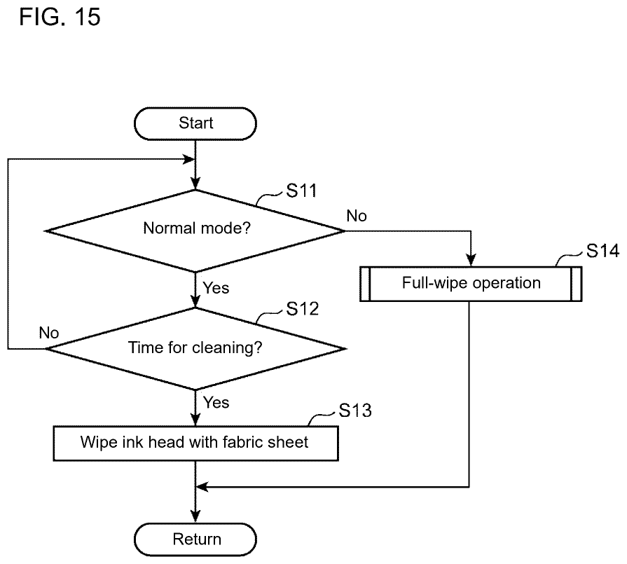

The pretreatment head 5 and the post-treatment head 6, which eject liquids free of pigment and binder resin, may undergo no fabric-wipe cleaning. Note that the ink heads 4 may undergo the fabric-wipe cleaning alone without undergoing the purging described above (described later with reference to FIG. 15). For the fabric-wipe cleaning, the carriage 3 is moved to the fabric wipe area 14 as illustrated in FIG. 4.

In the example described above, the blade BL is the first member that cleans both the ink heads 4 and the treatment heads 5 and 6, and the fabric sheet FS is the second member that cleans the ink heads 4 alone. The first member is mainly used to wipe most of the liquids on the nozzle placement surfaces 40 of the heads 4, 5, and 6 after the purging. In contrast, the second member is used to wipe the liquids remaining on the nozzle placement surfaces 40 or around the nozzle openings after the wiping. Note that cleaning with the first member and the second member may be performed while a liquid is being supplied to the nozzle placement surfaces 40. The liquid may be, for example, water. The nozzle placement surfaces 40 may be supplied with the liquid sprayed from a predetermined supply port or seeping out from a permeable component.

The first member used as described above may be a nonabsorbent wiper or a solid wiper without, for example, holes. The blade BL is an example of such a wiper. The first member may push away droplets on the nozzle placement surface 40 in a similar manner to a wiper wiping raindrops on a car window. Thus, the first member may or may not be absorbent to absorb droplets, and may be a spatula-shaped solid member. Commonly, the nozzle placement surfaces 40 of the heads 4, 5, and 6 are coated with a water-repellent film. To reduce damage to the water-repellent film as much as possible, the first member may be a nonabsorbent and solid member made of a rubber or resin material with a predetermined rigidity, rather than a metal member.

The second member may be an absorbent wiper or a porous wiper. An absorbent or porous wiper can absorb droplets remaining on the nozzle placement surfaces 40 or extra droplets at the nozzle openings. The fabric sheet FS is an example of such a wiper. The fabric sheet FS may be, for example, a woven of ultra-fine fibers. The second member may also be, for example, a foam with small bubble diameters, a sponge, or a sea sponge. The second member may be, of the examples described above, the fabric sheet FS that has low sliding resistance against the lower surface 3A of the carriage 3 and high absorbency. In the present embodiment, the first member and the second member are made of different materials or have different structures as described above.

### Details of Blade Wipe Device

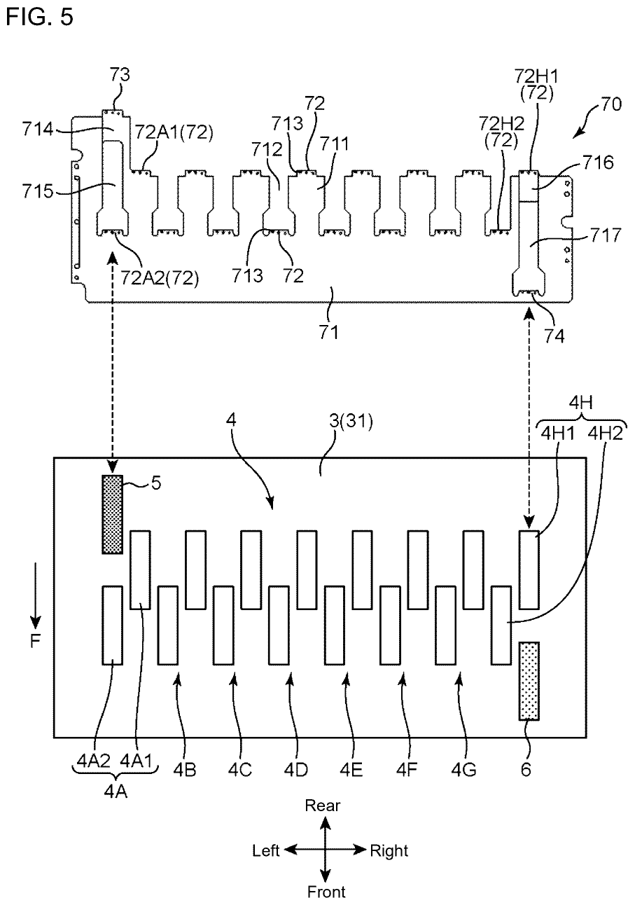

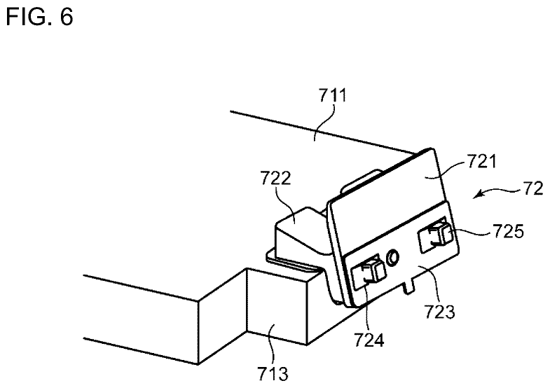

A specific example of the blade wipe device 7 will now be described with reference to FIGS. 4 to 7. FIG. 4 is a perspective view of the blade wipe device 7 illustrated in FIG. 1. The blade wipe device 7 includes a container unit 50 and the blade wiper 70. FIG. 5 is a plan view of the blade wiper 70 and the heads 4, 5, and 6 mounted on the carriage 3, illustrating the blade wiper 70 above and the heads 4, 5, and 6 below. FIG. 6 is a perspective view of an ink blade 72 included in the blade wiper 70. The ink blade 72 corresponds to the blade BL (first wiping member) illustrated in FIG. 1. FIG. 7 is a schematic cross-sectional view of the carriage 3 and the blade wiper 70.

As described above, blade cleaning follows purging of the heads 4, 5, and 6. The container unit 50 is a container to collect ink, the pretreatment liquid, and the post-treatment liquid ejected from the heads 4, 5, and 6 during the purging. The blade wiper 70 performs blade cleaning on the nozzle placement surfaces 40.

The container unit 50 collects the pretreatment separately from the ink and the post-treatment liquid. The pretreatment liquid improves the fixation of ink or facilitates aggregation of ink pigments. When the pretreatment liquid and the ink mix, the mixture aggregates and may not be smoothly collected into a waste liquid tank. In contrast, the post-treatment liquid does not, for example, aggregate when mixed with ink. The container unit 50 thus performs separate collection described above.

The container unit 50 includes an ink container 51 and a pretreatment liquid container 52 in a front portion of a frame structure 500, and a cleaning liquid tray 53 in a rear portion of the frame structure 500. The frame structure 500 includes a pair of right and left side frames 501 extending in the front-rear direction, and a front frame 502 connecting the front ends of the side frames 501. The front frame 502 receives a handle 503 for drawing the container unit 50 out. Multiple waste liquid hoses 504 are drawn out from below the front frame 502. The frame structure 500 also includes a slider 505 that allows the container unit 50 to be drawn out, and a chain protector 506 that accommodates electrical cables and hoses.

The ink container 51 collects ink and the post-treatment liquid ejected from the ink heads 4 and the post-treatment head 6 in the purging. The ink container 51 includes a first opening 51H in its upper surface to receive the ink and the post-treatment liquid. The ink container 51 includes a bottom surface 511 that is a laterally elongated rectangle, four tapered surfaces 512 extending upward from the respective four edges of the bottom surface 511, and an upper end flange 508 on the periphery of the first opening 51H. The ink container 51 also collects, in the blade cleaning, the ink and the post-treatment liquid wiped from the nozzle placement surfaces 40 (FIG. 7) of the ink heads 4 and the post-treatment head 6 exposed on the lower surface 3A of the carriage 3.

The pretreatment liquid container 52 partially covers an upper portion of the first opening 51H. The pretreatment liquid container 52 collects the pretreatment liquid ejected from the pretreatment head 5 in the purging. The pretreatment liquid container 52 includes a second opening 72H in its upper surface to receive the pretreatment liquid. The pretreatment liquid container 52 also collects the pretreatment liquid wiped from the nozzle placement surface 40 of the pretreatment head 5 in the blade cleaning. The cleaning liquid tray 53 collects a cleaning liquid CL (FIG. 7) for cleaning the dirty blade wiper 70 after the blade cleaning.

The container unit 50 includes an overflow channel 541, a treatment liquid channel 542, and a relay channel 543 for allowing the collected liquids to flow. The overflow channel 541 includes a starting open end on the bottom surface 511 of the ink container 51 and a terminal end directed toward a waste liquid container (not illustrated). The treatment liquid channel 542 includes a starting open end near the bottom surface of the pretreatment liquid container 52 and a terminal end directed toward the waste liquid container. The relay channel 543 includes a starting open end on the bottom surface of the cleaning liquid tray 53 and a terminal open end near the bottom surface 511 of the ink container 51.

A rubber cap 55 is attached to an upper surface 50A of the container unit 50. The rubber cap 55 surrounds the periphery of the first opening 51H of the ink container 51. The carriage 3 is movable in a vertical direction as indicated by arrow A1 in FIG. 7. For example, when the carriage 3 is in a standby mode in the blade wipe area 13 or when the printer 1 is idle, the carriage 3 is lowered to cause the lower surface 3A of the head support frame 31 to come in contact with the rubber cap 55. This hermetically seals the nozzle placement surfaces 40 of the heads 4, 5, and 6.

A cleaning unit 56 is located above the cleaning liquid tray 53. The cleaning unit 56 jets the cleaning liquid CL in the blade wiper 70. The cleaning unit 56 includes a nozzle holder plate 561 and multiple cleaning nozzles 562 held by the nozzle holder plate 561. The cleaning nozzles 562 spray the cleaning liquid CL in a fan shape toward blades 72, 73, and 74 (described later) in the blade wiper 70. The cleaning liquid CL is supplied to the cleaning nozzles 562 from a cleaning liquid tank (not illustrated) through cleaning liquid hoses 563.

The blade wiper 70 includes a blade support plate 71 and a blade group of the ink blades 72, the pretreatment liquid blade 73, and the post-treatment liquid blade 74 supported on the blade support plate 71. The blade wiper 70 is movable in the front-rear direction as indicated by arrow A2 in FIG. 7. The blade support plate 71 is a flat plate and moves in the front-rear direction under the carriage 3 and the cleaning unit 56 and above the container unit 50. The ink blades 72 in contact with the nozzle placement surfaces 40 of the ink heads 4 exposed on the lower surface 3A move rearward to wipe the nozzle placement surfaces 40. In the same or a similar manner, the pretreatment liquid blade 73 wipes the nozzle placement surface 40 of the pretreatment head 5, and the post-treatment liquid blade 74 wipes the nozzle placement surface 40 of the post-treatment head 6. More specifically, the blade wiper 70 can wipe the nozzle placement surfaces 40 of all the heads 4, 5, and 6 at the same time by moving rearward once.

The structure of the blade wiper 70 will be described further in detail. The upper part of FIG. 5 is a plan view of the blade support plate 71 holding the blades 72, 73, and 74. The lower part of FIG. 5 illustrates the arrangement of the heads 4, 5, and 6 mounted on the carriage 3 and the correspondence between the heads 4, 5, and 6 and the blades 72, 73, and 74. The heads 4, 5, and 6 illustrated in the lower part of FIG. 5 are arranged in the same manner as the above example illustrated in FIG. 3.

The blade support plate 71 includes multiple strip-shaped protruding plates 711. The multiple protruding plates 711 protrude rearward, or in a movement direction in wiping. The protruding plates 711 are adjacent to one another with recesses 712 between them. The recesses 712 extend frontward. Edges (rear ends) of the protruding plates 711 and edges defining the recesses 712 receive the ink blades 72 that wipe the nozzle placement surfaces 40 of the ink heads 4. The ink blades 72 at the edges of the protruding plates 711, including, for example, an ink blade 72A1 for the upstream head 4A1 in the first ink head 4A, wipe the upstream heads in the ink heads 4 for different colors. The ink blades 72 at the edges defining the recesses 712, including, for example, an ink blade 72A2 for the downstream head 4A2, wipe the downstream heads in the ink heads 4 for different colors.

The pretreatment liquid blade 73 that wipes the nozzle placement surface 40 of the pretreatment head 5 is attached to an edge (rear end) of a protruding portion 714 protruding more rearward than the other areas of the blade support plate 71. The protruding portion 714 extends further rearward from the rear end of the leftmost protruding plate 711. A window 715 corresponding to the recesses 712 is defined in front of the protruding portion 714. In this manner, the pretreatment liquid blade 73 is located at a portion of the blade support plate 71 protruding most in the movement direction. This can reduce the likelihood of the pretreatment liquid wiped by the pretreatment liquid blade 73 being deposited on other portions of the blade support plate 71.

The post-treatment liquid blade 74 that wipes the nozzle placement surface 40 of the post-treatment head 6 is attached to the blade support plate 71 at a position near the front right end of the blade support plate 71. The post-treatment head 6 and the upstream head 4H1 in the eighth ink head 4H are aligned at upstream and downstream positions in the transport direction F. The blade support plate 71 corresponding to the heads arranged as described above includes a holder piece 716 and a window 717 near its right end. The holder piece 716 supports, at its rear edge, an ink blade 72H1 that wipes the upstream head 4H1. The recess 712 adjacent to the left side of the holder piece 716 is defined with an edge supporting an ink blade 72H2 that wipes the downstream head 4H2. The window 717 is an opening in front of the holder piece 716. The post-treatment liquid blade 74 is supported at a front opening edge of the window 717.

The blade support plate 71 includes multiple protrusions 713 arranged to correspond to the respective blades 72, 73, and 74 described above. The protrusions 713 are each continuous with the corresponding one of the rear ends of the protruding plates 711, the basal edges of the recesses 712, the rear end of the protruding portion 714, and the basal edge of the window 717. The protrusions 713 as viewed vertically are small protrusions protruding in the movement direction in wiping. The blades 72, 73, and 74 are arranged on their corresponding protrusions 713. This arrangement reduces the likelihood of the ink or the treatment liquids on the blades 72, 73, and 74 being deposited on the blade support plate 71.

FIG. 6 illustrates a detailed structure of the ink blade 72 corresponding to the blade BL (first member) in FIG. 1. The pretreatment liquid blade 73 and the post-treatment liquid blade 74 also have the same or a similar structure. The ink blade 72 includes a blade body 721, a first holder 722, and a second holder 723. The blade body 721 is a spatula-like plate that physically comes in contact with and wipes a nozzle placement surface 40. The blade body 721 includes an upper end protruding upward from the upper surface of the blade support plate 71.

The first holder 722 and the second holder 723 hold the blade body 721 between them. The first holder 722 is fitted in a recess on the protrusion 713 and fastened with screws to support a lower portion of the back surface of the blade body 721. The second holder 723 is attached to the blade body 721 along a lower portion of the front surface of the blade body 721. The second holder 723 includes a pair of openings 724. The blade body 721 also includes through-holes at the same positions as the openings 724. The first holder 722 includes a pair of tabs 725. The tabs 725 are placed through the through-holes and the openings 724, engaging with the second holder 723 at the peripheries of the openings 724. The blade body 721 is held between the first holder 722 and the second holder 723 under the engagement force.

### Details of Fabric Wipe Device

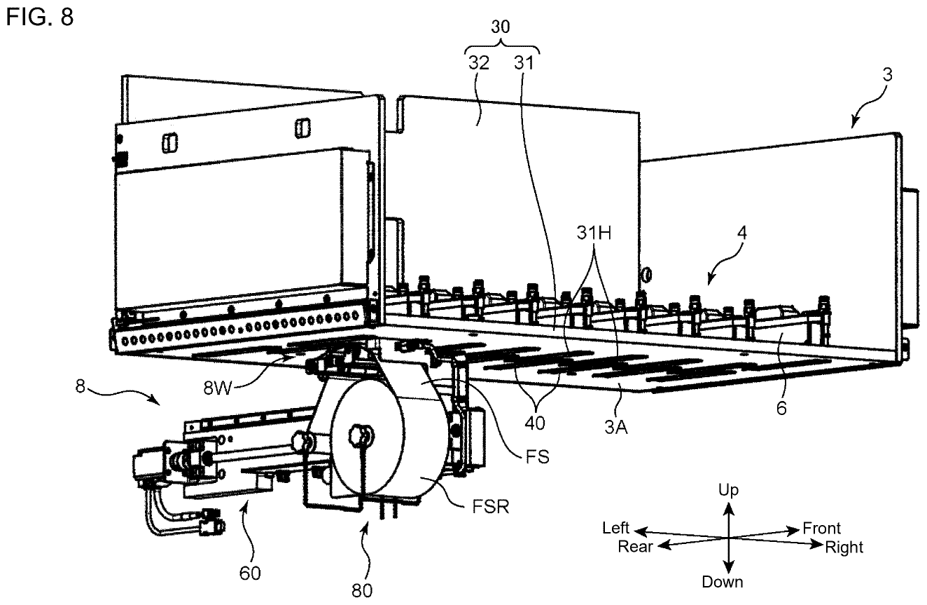

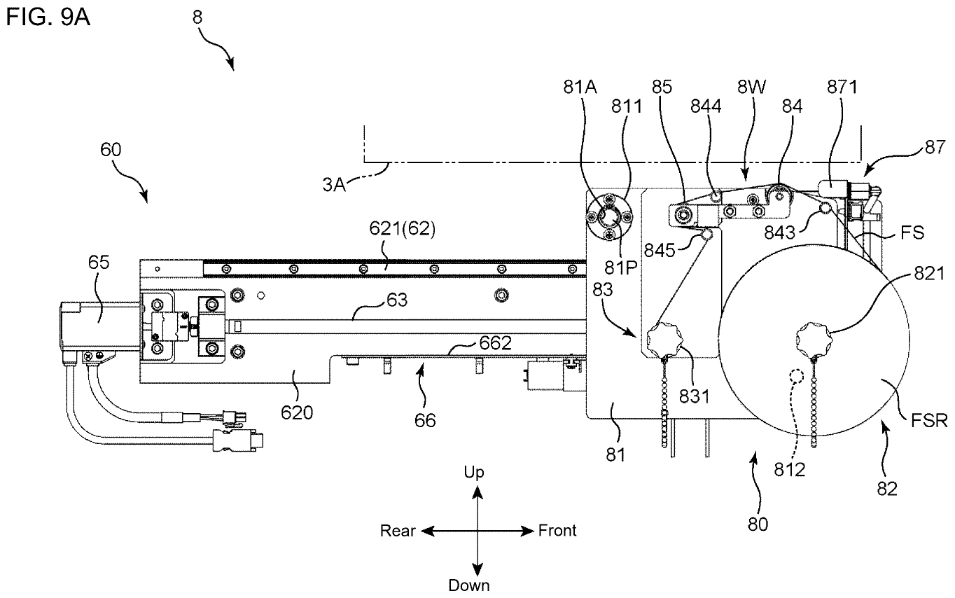

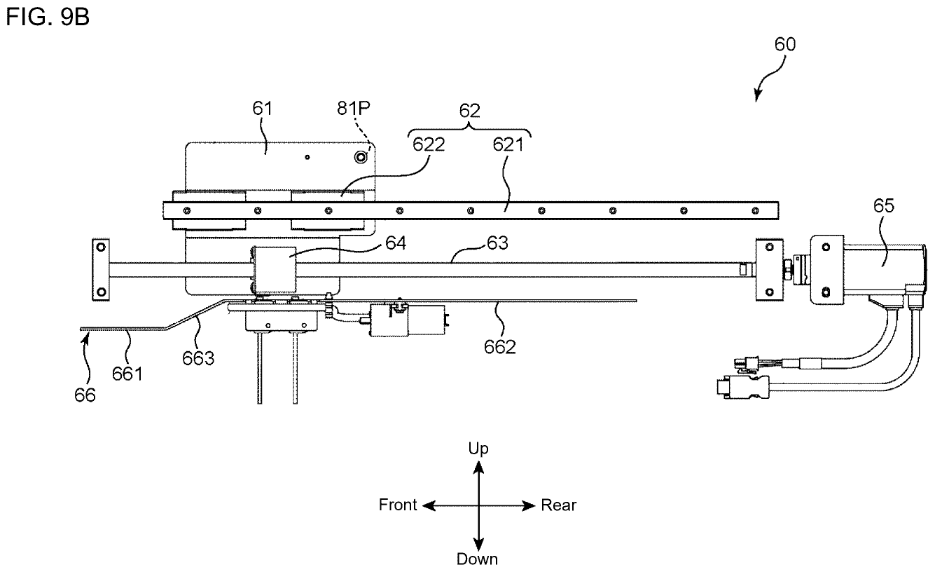

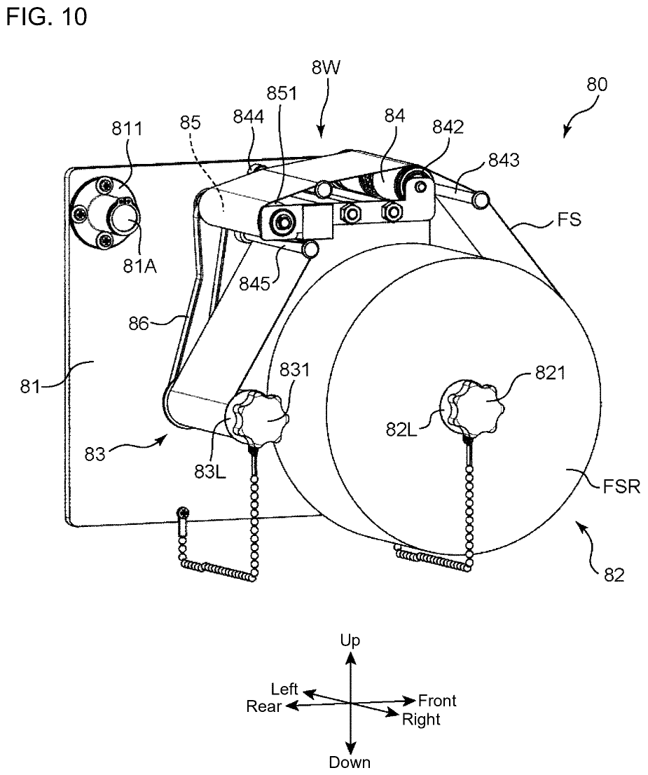

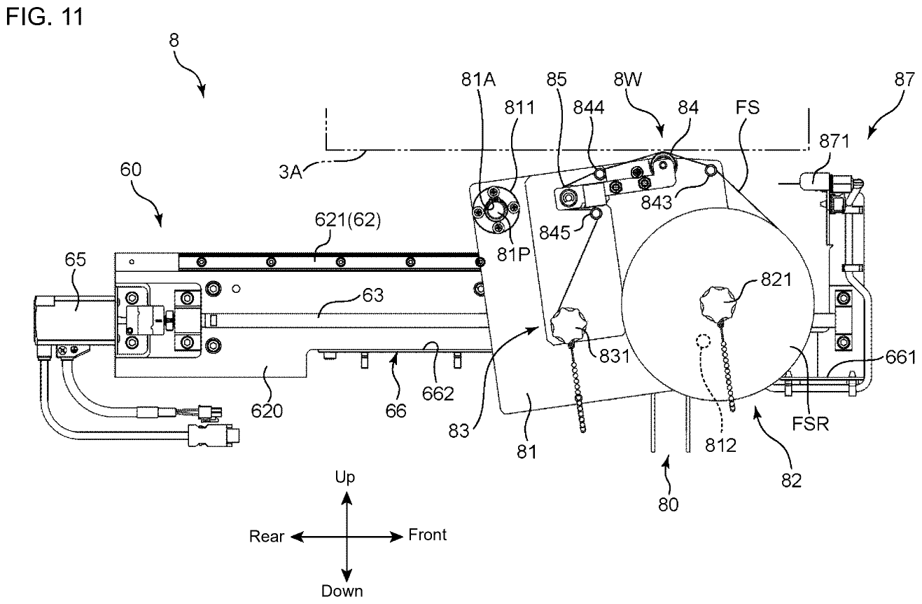

The specific example of the fabric wipe device 8 will now be described with reference to FIGS. 8 to 11. FIG. 8 is a perspective view of the fabric wipe device 8 in fabric-wipe cleaning. The fabric wipe device 8 includes a mover 60 and the fabric wiper 80. FIG. 9A is a left side view of the fabric wipe device 8. FIG. 9B is a side view of the mover 60. FIG. 10 is a perspective view of the fabric wiper 80. FIG. 11 is a view of the fabric wiper 80 in a cleaning orientation.

The fabric wiper 80 includes a fabric sheet roll FSR, which is a bundle of a fabric sheet for fabric wipe. The mover 60 moves the fabric wiper 80 in the front-rear direction. In fabric-wipe cleaning, a wipe portion 8W of a fabric sheet FS unwound from the fabric sheet roll FSR is pressed against the nozzle placement surfaces 40 of the ink heads 4 exposed on the lower surface 3A of the carriage 3. FIG. 8 illustrates this pressed state. The mover 60 moves the fabric wiper 80 rearward in this pressed state to wipe the nozzle placement surfaces 40 with the fabric sheet FS defining the wipe portion 8W.

The fabric wiper 80 physically performs fabric-wipe cleaning. The mover 60 moves the fabric wiper 80 between a cleaning position at which the fabric wiper 80 cleans the lower surface 3A (nozzle placement surfaces 40) and a retracted position at which the fabric wiper 80 does not clean the lower surface 3A. The fabric wiper 80 illustrated in FIG. 9A is at the retracted position. The fabric wiper 80 illustrated in FIG. 11 is at the cleaning position.

The mover 60 includes a movable plate 61, a linear guide 62, a ball screw 63, a nut 64, a fabric wiper motor 65, and an orientation switch guide 66.

The movable plate 61 is a substantially rectangular flat plate as viewed laterally. The movable plate 61 is movable in the front-rear direction along the linear guide 62. The fabric wiper 80 is mounted on the movable plate 61. A pivot pin 81P protruding leftward is attached to the movable plate 61 near the upper rear corner of the movable plate 61. The pivot pin 81P serves as a pivot of the fabric wiper 80. The fabric wiper 80 is mounted on the movable plate 61 in a manner pivotable about the pivot pin 81P.

The linear guide 62 includes a guide base 620, a guide rail 621, and a block 622. The guide base 620 is a flat plate serving as a base to which the guide rail 621, the ball screw 63, the fabric wiper motor 65, and the orientation switch guide 66 are attached. The guide base 620 is not illustrated in FIG. 9A. The guide rail 621 is a rail extending linearly in the front-rear direction. The block 622 is fitted on the guide rail 621 to move in the front-rear direction along the guide rail 621. The movable plate 61 is fixed to the block 622.

The ball screw 63 is axially supported by the guide base 620 to extend parallel to the guide rail 621 in the front-rear direction. The nut 64 is screwed on the ball screw 63 and attached to the movable plate 61. The fabric wiper motor 65 includes a motor shaft connected to the rear end of the ball screw 63 to rotate the ball screw 63 forward or reversely about the shaft. When the ball screw 63 is rotated, the nut 64 moves in the front-rear direction, causing the movable plate 61 to move in the front-rear direction while being guided along the guide rail 621.

The orientation switch guide 66 comes in contact with a contact portion 812 of the fabric wiper 80 when the movable plate 61 moves. The pivot orientation of the fabric wiper 80 about the pivot pin 81P is switched based on the position at which the contact portion 812 comes in contact with the orientation switch guide 66. The orientation switch guide 66 includes a first horizontal portion 661, a second horizontal portion 662, and a slope 663. The first horizontal portion 661 extends horizontally at the predetermined height in a direction in which the linear guide 62 extends. The second horizontal portion 662 is at a position higher than the first horizontal portion 661 by a predetermined height. The second horizontal portion 662 extends horizontally in the front-rear direction at a position spaced rearward from the first horizontal portion 661. The slope 663 connects the first horizontal portion 661 and the second horizontal portion 662 having a height difference.

The fabric wiper 80 includes a base plate 81, a feeder portion 82, a takeup portion 83, a press roller 84, a transport roller 85, and a transmission belt 86. The base plate 81 is a substantially square flat plate larger than the movable plate 61 as viewed laterally. A bearing bush 811 protrudes from the right surface of the base plate 81 near the upper rear corner of the base plate 81. The bearing bush 811 includes a rotation shaft hole 81A through which the pivot pin 81P in the movable plate 61 is placed. The base plate 81 is pivotable relative to the movable plate 61 about the bearing bush 811 serving as a pivot axially supported by the pivot pin 81P.

The contact portion 812 protrudes from the left surface of the base plate 81 near the lower front corner of the base plate 81. The contact portion 812 is, for example, a roller rotatable about an axis extending in the lateral direction. The corner at which the contact portion 812 is located is diagonal to the corner at which the bearing bush 811 is located. The contact portion 812 is in contact with the orientation switch guide 66. In FIG. 9A, the contact portion 812 is in contact with the first horizontal portion 661 of the orientation switch guide 66, and the base plate 81 is in a horizontal orientation. In FIG. 11, the contact portion 812 is in contact with the second horizontal portion 662 at a position higher than the first horizontal portion 661, and the base plate 81 pivots about the pivot pin 81P to have its front portion lifted.

The feeder portion 82 and the takeup portion 83 are joined to the base plate 81. The feeder portion 82 unwinds the fabric sheet FS for fabric-wipe cleaning. The feeder portion 82 includes an unwinding roller 821 that holds the fabric sheet roll FSR that is a wound body of an unused portion of the fabric sheet FS. The unwinding roller 821 receives a torque limiter 82L on its rotational shaft. The takeup portion 83 rewinds the fabric sheet FS used in fabric-wipe cleaning. The takeup portion 83 includes a winding roller 831 around which a used portion of the fabric sheet FS is wound. The winding roller 831 also receives a torque limiter 83L on its rotational shaft.

The wipe portion 8W of the fabric sheet FS extends between the feeder portion 82 and the takeup portion 83. The wipe portion 8W is a portion of the elongated fabric sheet FS wound as the fabric sheet roll FSR. The wipe portion 8W is pressed against the lower surface 3A of the carriage 3 to physically wipe the nozzle placement surfaces 40 in fabric-wipe cleaning. The wipe portion 8W is sequentially fed with an unused portion of fabric sheet FS from the fabric sheet roll FSR in the feeder portion 82. The fabric sheet FS in the wipe portion 8W used in the fabric-wipe cleaning is sequentially rewound by the takeup portion 83.

The press roller 84 is an elastic roller. The press roller 84 supports the fabric sheet FS in the wipe portion 8W. The press roller 84 presses the fabric sheet FS in the wipe portion 8W against the lower surface 3A. The press roller 84 is axially supported near the upper side of the base plate 81 to partially protrude upward from the upper side of the base plate 81. The press roller 84 supports the fabric sheet FS from below to cause the fabric sheet FS in the wipe portion 8W to also protrude upward from the upper side of the base plate 81.

The press roller 84 receives a one-way clutch (not illustrated) on its rotational shaft. The one-way clutch rotates the press roller 84 only in a direction in which the fabric sheet FS is unwound. The press roller 84 receives a pair of pulleys 842 on both ends of the rotational shaft. Whereas the press roller 84 is elastically deformable, the pulleys 842 are made of a hard material that is substantially elastically nondeformable. When the pair of pulleys 842 are pressed against the lower surface 3A, the pulleys 842 determine the positional relationship between the press roller 84 and the nozzle placement surfaces 40. The extent by which the fabric sheet FS is pressed onto the nozzle placement surfaces 40 by the press roller 84 can thus be constant and axially uniform.

In the unwinding direction of the fabric sheet FS, a first guide roller 843 is located upstream from the press roller 84, and a second guide roller 844 is located downstream from the press roller 84. The transport roller 85 and a tension roller 845 are arranged in order downstream from the second guide roller 844. The transport roller 85 feeds the fabric sheet FS from the feeder portion 82 toward the takeup portion 83 through the wipe portion 8W. The transport roller 85 receives a one-way clutch 851 on its rotational shaft. The tension roller 845 applies tension to the fabric sheet FS being rewound by the takeup portion 83.

The transport roller 85 receives a gear (not illustrated) on an end of its shaft. When the base plate 81 pivots relative to the movable plate 61 about the bearing bush 811 serving as a pivot, a drive force is applied to the gear and the transport roller 85 rotates. The fabric sheet FS is fed downstream by the degree of rotation of the transport roller 85. The rotation of the transport roller 85 also causes a used portion of the fabric sheet FS to be rewound by the takeup portion 83. As illustrated in FIG. 10, the transmission belt 86 extends between the transport roller 85 and the winding roller 831. When the transport roller 85 rotates by a predetermined degree in response to switching of the orientation of the fabric wiper 80, the rotation is transmitted to the winding roller 831 by the transmission belt 86. The winding roller 831 thus winds the fabric sheet FS by the degree of rotation of the transport roller 85.

A spray unit 87 is located between the first guide roller 843 and the press roller 84. The spray unit 87 includes a spray gun 871 that blows a cleaning liquid that is pure water or a liquid containing a cleaning component. The spray unit 87 is attached to the left side plate of the apparatus frame 10. The spray gun 871 sprays the cleaning liquid onto the fabric sheet FS in the wipe portion 8W upstream from the press roller 84. The fabric sheet FS wetted with the cleaning liquid immediately before fabric-wipe cleaning can increase the efficiency of cleaning the nozzle placement surfaces 40.

FIG. 9A illustrates the fabric wiper 80 in the retracted orientation in which the fabric wiper 80 does not clean the nozzle placement surfaces 40. FIG. 11 illustrates the fabric wiper 80 in the cleaning orientation in which the fabric wiper 80 cleans the nozzle placement surfaces 40. When the fabric wiper motor 65 in the state illustrated in FIG. 9A is driven to move the movable plate 61 rearward, the fabric wiper 80 also moves rearward. The contact portion 812 in contact with the first horizontal portion 661 (FIG. 9B) of the orientation switch guide 66 comes in contact with the slope 663. As the contact portion 812 moves up on the slope 663, the base plate 81 pivots about the bearing bush 811 serving as the pivot and placed through the pivot pin 81P, having the front end portion of the base plate being lifted.

In FIG. 11, the contact portion 812 has moved up to the second horizontal portion 662 through the slope 663. The contact portion 812 is lifted by the amount corresponding to the height difference between the first horizontal portion 661 and the second horizontal portion 662. The base plate 81 pivots about the pivot pin 81P by the rotation angle corresponding to the lifted amount. This pivot lifts the wipe portion 8W, causing the portion of the fabric sheet FS supported by the press roller 84 to come in contact with the lower surface 3A (nozzle placement surfaces 40). More specifically, the lower surface 3A can be cleaned with the fabric sheet FS in the wipe portion 8W.

The movable plate 61 is further moved rearward as being driven by the fabric wiper motor 65. This allows cleaning of the nozzle placement surfaces 40 with the fabric sheet FS in the wipe portion 8W. In the present embodiment, as illustrated in FIG. 3, the ink heads 4 for different colors are aligned in two rows in the front-rear direction. The fabric sheet FS has a width that can cover two ink heads 4 arranged in the main scanning direction S. Thus, the wipe portion 8W may be moved by at least the distance corresponding to the stroke for the two front-rear rows. The second horizontal portion 662 of the orientation switch guide 66 thus has a length in the front-rear direction longer than the stroke.

After the wipe portion 8W is moved to the rear end to complete the fabric-wipe cleaning, the carriage 3 is lifted by a small amount to separate the wipe portion 8W from the lower surface 3A. The movable plate 61 is then driven by the fabric wiper motor 65 to return to a front position. The position with which the contact portion 812 is in contact then changes from the second horizontal portion 6622 to the slope 663 and to the first horizontal portion 661. This causes the base plate 81 to pivot about the pivot pin 81P, and the fabric wiper 80 returns to the horizontal state, or to the retracted orientation. The carriage 3 is then moved in the main scanning direction S by a distance corresponding to two heads for fabric-wipe cleaning of the next set of ink heads 4. The fabric-wipe cleaning is repeated with the procedure described above.

### Control Structure

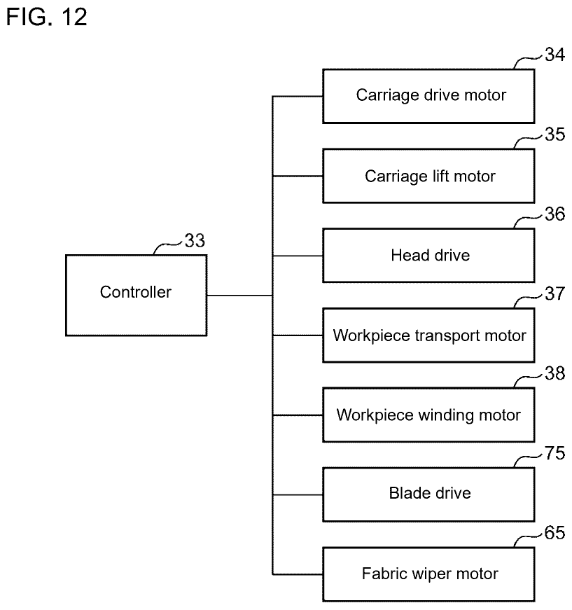

FIG. 12 is a block diagram of the printer 1 partially illustrating its control configuration. The printer 1 includes a controller 33, a carriage drive motor 34, a carriage lift motor 35, a head drive 36, a workpiece transport motor 37, a workpiece winding motor 38, a blade drive 75, and the fabric wiper motor 65. The operations of these components other than the controller 33 are controlled by the controller 33.

The carriage drive motor 34 generates a driving force for laterally moving the carriage 3 between the blade wipe area 13 and the fabric wipe area 14 through the printing area 12. The carriage drive motor 34 corresponds to the linear motor 16 illustrated in FIG. 1. The carriage lift motor 35 generates a driving force for vertically moving the carriage 3 in the blade wipe area 13 and the fabric wipe area 14. The head drive 36 causes ejection of ink, a pretreatment liquid, and a post-treatment liquid from the heads 4, 5, and 6. The workpiece transport motor 37 is a driving source for transporting the workpiece W in the transport direction F in the printer 1. In the example in FIG. 2, drive motors such as the transport roller 25 and the drive roller 201 in the transport unit 20 correspond to the workpiece transport motor 37. The workpiece winding motor 38 is a driving source for rotating the winding roller 22 to wind the printed workpiece W.

The blade drive 75 causes, under control performed by the controller 33, the blade wipe device 7 to operate to perform maintenance including purging and blade cleaning of the heads 4, 5, and 6. More specifically, the blade drive 75 causes, as purging, the heads 4, 5, and 6 to respectively eject high-pressure ink, a pretreatment liquid, and a post-treatment liquid to clean the nozzles. In blade cleaning, the blades 72, 73, and 74 in the blade wiper 70 are moved near the nozzle placement surfaces 40 of the heads 4, 5, and 6 during contactless wipe (described later), and are moved on the nozzle placement surfaces 40 during contact wipe.

The fabric wiper motor 65 moves, under control performed by the controller 33, the movable plate 61 on which the fabric wiper 80 is mounted to perform the fabric-wipe cleaning of the ink heads 4. The controller 33 sets a cleaning sequence for cleaning the nozzle placement surfaces 40 with the fabric wiper 80 to control, for example, the fabric wiper motor 65 and the carriage drive motor 34 based on the cleaning sequence.

The controller 33 includes, for example, a processor that operates based on a program. The controller 33 centrally controls the operations of components in the printer 1. In controlling cleaning of the heads 4, 5, and 6, the controller 33 controls the blade wipe device 7 (first device) and the fabric wipe device 8 (second device) to perform appropriate blade cleaning and fabric-wipe cleaning.

For the ink heads 4, the controller 33 causes both the blade wipe device 7 and the fabric wipe device 8 to wipe the nozzle placement surfaces 40 in two-stage wiping (two-stage cleaning). In the wiping, the blade wipe device 7 wipes the nozzle placement surface 40 first, and then the fabric wipe device 8 wipes the nozzle placement surfaces 40. In wiping the ink heads 4, the controller 33 causes the blade wipe device 7 to sequentially perform a first wipe (first cleaning) and a second wipe (second cleaning). In the first wipe, the ink blades 72 are not in contact with the nozzle placement surfaces 40. In the second wipe, the ink blades 72 are in contact with the nozzle placement surfaces 40. For the pretreatment head 5 and the post-treatment head 6, the controller 33 causes the blade wipe device 7 alone to wipe the nozzle placement surfaces 40. Note that the controller 33 causes the heads 4, 5, and 6 to be purged to forcibly eject ink and the treatment liquids before the blade wipe device 7 performs the blade cleaning.

### Specific Example of Cleaning Control for Heads

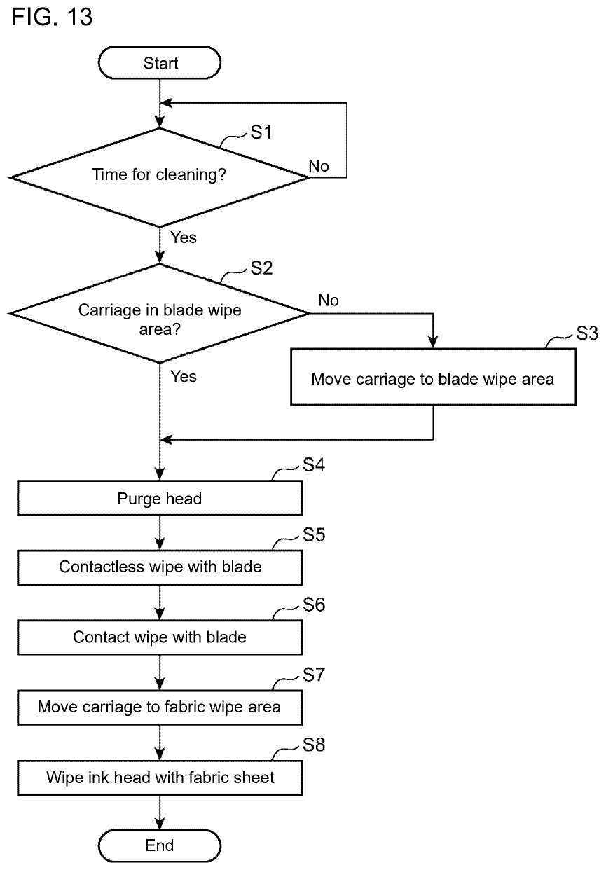

A specific example of cleaning control performed by the controller 33 described above will now be described with reference to the flowcharts illustrated in FIGS. 13 and 15. FIG. 13 is a flowchart showing an example operation of cleaning the heads 4, 5, and 6 in the printer 1. The controller 33 determines whether the time for cleaning has arrived (step S1). The time for cleaning is determined based on the cumulative print time or printed area, or the number of operating days from the last head cleaning. Note that the time for cleaning may be determined based on, in addition to the periodic factors mentioned above, nonperiodic factors, such as continuous high density printing or detection of a non-ejecting head. When the time for cleaning has not arrived (No in step S1), the controller 33 sets the blade wipe device 7 and the fabric wipe device 8 on standby.

When the time for cleaning has arrived (Yes in step S1), the determination is performed as to whether the carriage 3 is in the blade wipe area 13 (step S2). When the carriage 3 is not in the blade wipe area 13 (No in step S2), the controller 33 controls the carriage drive motor 34 to move the carriage 3 to the blade wipe area 13 (step S3).

When the carriage 3 is in the blade wipe area 13 (Yes in step S2), the controller 33 performs the blade cleaning operation. The controller 33 controls the blade drive 75 to first cause the heads 4, 5, and 6 to be purged to forcibly eject ink and the treatment liquids (step S4). For example, the purging removes air bubbles trapped in the nozzles of the heads 4, 5, and 6, or blows off solids deposited on the nozzle placement surfaces 40 with the purge flow. For the ink heads 4, the purging also softens solids derived from ink with the purge flow for easier removal.

The purge volume may be set to the range of about 3 to 60 ml per head. Note that the ink heads 4 alone may be purged. When a specific ink head 4 alone includes clogged nozzles, the specific head alone may be purged. In this case, to reduce adverse effects on the heads (damage to the water-repellent film) caused by dry wipe, a small amount (about 0.2 to 1.0 ml) of ink or the treatment liquid may also be ejected from the heads other than the specific ink head 4.

The controller 33 then causes the blade wiper 70 to perform contactless wipe (first cleaning) on the heads 4, 5, and 6 (step S5). In the contactless wipe, wiping is performed with a gap between the blade bodies 721 of the ink blades 72 and the nozzle placement surfaces 40 of the ink heads 4. The gap is about 0.2 to 0.8 mm wide. The same or a similar structure applies to the pretreatment head 5 and the post-treatment head 6. The controller 33 controls the carriage lift motor 35 to lower the carriage 3 and define the gap. The contactless wipe wipes droplets dripping from the nozzle placement surfaces 40 of the heads 4, 5, and 6. The blade wiper 70 performing the contactless wipe may move at a speed selected from the range of about 10 to 100 mm/s.

The controller 33 then causes the blade wiper 70 to perform contact wipe (second cleaning) on the heads 4, 5, and 6 (step S6). In the contact wipe, the blade bodies 721 of the ink blades 72 are pressed against the nozzle placement surfaces 40 of the ink heads 4 for cleaning. The same or a similar structure applies to the pretreatment head 5 and the post-treatment head 6. A pressing force (linear pressure) in the pressing may be set to about 0.1 to 10 N/m. The controller 33 lowers the carriage 3 to achieve the pressing force. In the contact wipe, the blade wiper 70 may also move at a speed selected from the range of about 10 to 100 mm/s.

FIGS. 14A to 14C are schematic diagrams illustrating the cleaning procedures in steps S4 to S6 described above. The figures illustrate one ink head 4 and one ink blade 72 for wiping the head 4. FIG. 14A illustrates the purging in step S4. The ink head 4 ejects a purged liquid PA, or ink, from the nozzle placement surface 40.

FIG. 14B illustrates the contactless wipe in step S5. The ink blade 72 (blade body 721) and the nozzle placement surface 40 define the gap described above. The blade support plate 71 receiving the ink blade 72 is moved relative to the carriage frame 30. Droplets DR on the nozzle placement surface 40 are wiped with the ink blade 72.

FIG. 14C illustrates the contact wipe in step S6. The ink blade 72 is in contact with the nozzle placement surface 40 and is deformed by the pressing force. The blade support plate 71 in this state is moved relative to the carriage frame 30. The nozzle placement surface 40 is thus wiped with the ink blade 72. In this manner, the nozzle placement surface 40 is cleaned through two-stage wiping including the contactless wipe and the contact wipe. The contactless wipe, in which the ink blades 72 are not in contact with the nozzle placement surfaces 40, does not affect the water-repellent film coating the nozzle placement surfaces 40. When all the droplets DR are removed by the blades performing the contact wipe, the water-repellent film may be easily damaged. As in the present embodiment, the contactless wipe of wiping the droplets DR in advance can improve the efficiency of cleaning the nozzle placement surfaces 40 and reduce damage to the water-repellent film.

Referring back to FIG. 13, after the blade cleaning in steps S4 to S6, the controller 33 drives the carriage lift motor 35 to lift the carriage 3 and moves the nozzle placement surface 40 apart from the ink blade 72. The controller 33 then controls the carriage drive motor 34 to move the carriage 3 to the fabric wipe area 14 (step S7). The controller 33 causes the moved carriage 3 to be lowered until the nozzle placement surface 40 is at a predetermined height. The controller 33 then drives the fabric wiper motor 65, causing the fabric wiper 80 to perform the fabric-wipe cleaning on the nozzle placement surfaces 40 of the ink heads 4 (step S8).

More specifically, the movable plate 61 in the mover 60 moves relative to the carriage frame 30, and the fabric sheet FS wipes the nozzle placement surfaces 40. Before the wiping, the fabric sheet FS is sprayed with a cleaning liquid from the spray unit 87. The cleaning liquid may contain a surfactant that reduces surface tension to protect the water-repellent film on the nozzle placement surfaces 40. The press roller 84 causes the fabric sheet FS to apply a pressing force to the nozzle placement surfaces 40. The pressing force may be in the range of 0.02 to 0.20 N/mm² , or more specifically 0.05 to 0.15 N/mm². The fabric sheet FS can move at a relative movement speed selected from the range of about 10 to 100 mm/s.

The control shown in FIG. 13 may be referred to as a “full-wipe operation” in which the purging of the heads 4, 5, and 6, the contactless and contact wiping of the heads 4, 5, and 6 with the blades 72, 73, and 74, and the wiping of the ink heads 4 with the fabric sheet FS are performed in this order. The full-wipe operation may not be performed on all occasions, and may be performed as appropriate.

FIG. 15 is a flowchart showing an example control to selectively perform the full-wipe operation. The controller 33 determines whether the printer 1 is currently in a “normal mode” (step S11). The “normal mode” refers to a state without an accident such as non-ejecting nozzles being detected or an ongoing event of continuous high density printing. In the “normal mode,” periodic fabric-wipe cleaning alone may be performed on the ink heads 4.

In the “normal mode” (Yes in step S11), the controller 33 determines whether the time for cleaning has arrived (step S12). When the time for cleaning has arrived (Yes in step S12), the controller 33 causes the carriage 3 to move to the fabric wipe area 14 and causes the fabric wipe device 8 to wipe the ink heads 4 with the fabric sheet FS (step S13). When the time for cleaning has not arrived (No in step S12), the controller 33 sets the blade wipe device 7 and the fabric wipe device 8 on standby.

In a mode other than the “normal mode” (No in step S11), the controller 33 causes the blade wipe device 7 and the fabric wipe device 8 to operate as appropriate to perform the “full-wipe operation” illustrated as in the example in FIG. 13 (step S14). Note that an ink head 4 with non-ejecting nozzles may sequentially undergo the fabric-wipe cleaning performed with the fabric wipe device 8 and then, when the ink head 4 does not recover from a non-ejection state, the “full-wipe operation.”

### Variation of Embodiment of Printer

In the printer 1 illustrated in FIG. 1, the blade wipe device 7 is in the blade wipe area 13 located in the right portion of the printing area 12, and the fabric wipe device 8 is in the fabric wipe area 14 located in the left portion of the printing area 12. The blade wipe device 7 and the fabric wipe device 8 may not be arranged as described above, and may both be located in one side portion of the printing area 12.

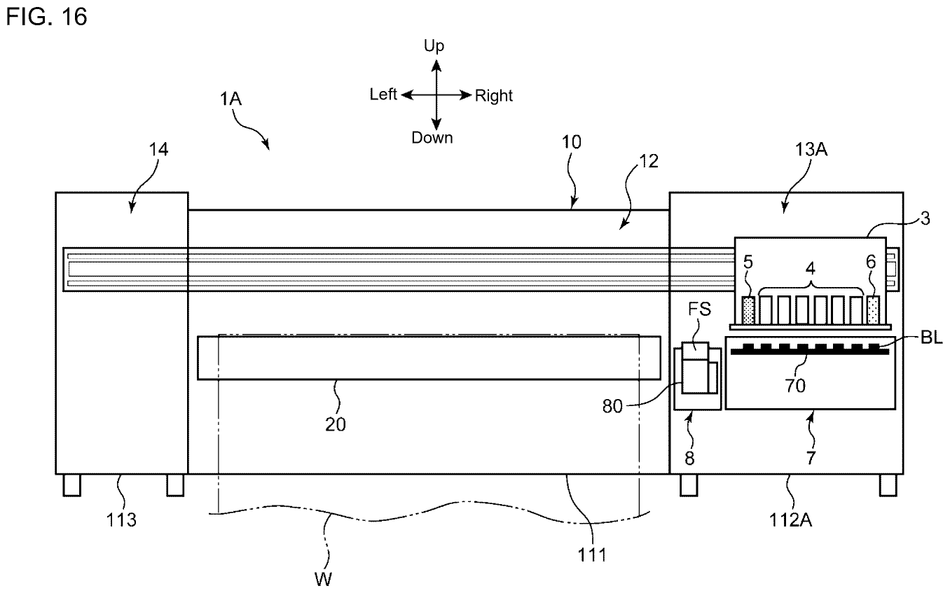

FIG. 16 is a front view of an inkjet printer 1A according to a variation of the embodiment, illustrating its overall structure. A right frame 112A is located in the right portion of the printing area 12 to define a maintenance area 13A. The maintenance area 13A accommodates the blade wipe device 7 and the fabric wipe device 8. More specifically, both the blade cleaning and the fabric-wipe cleaning can be performed in the maintenance area 13A in the printer 1A.

In the printer 1 in FIG. 1, the right and left areas in the printing area 12 for the carriage 3 to reciprocate are used as the blade wipe area 13 and the fabric wipe area 14. The printer 1 can thus be smaller. However, the carriage 3 after the blade cleaning in the blade wipe area 13 is to move to the fabric wipe area 14 before the fabric-wipe cleaning. The printer 1A according to the variation of the embodiment, in contrast, can perform both the blade cleaning and the fabric-wipe cleaning in the maintenance area 13A by simply moving the carriage 3 slightly. The maintenance time can thus be shorter. Additionally, components associated with head cleaning, such as cleaning liquid supply pipes, liquid-waste pipes, and tanks, can be concentrated near the maintenance area 13A, and thus can also be arranged simply and efficiently.

The printer according to one or more embodiment of the present disclosure is not limited to the above structures, and may have various variations. In the above embodiment, the members are made of different materials, such as the blade BL for the first member and the fabric sheet FS for the second member, and the manner of cleaning is wiping. The meaning of the first member and the second member being “different” is not limited to the first member and the second member being made of different materials, and can be construed diversely. For example, the first member and the second member may be different in (1) structure, (2) cleaning method, or (3) characteristic.

Examples of (1) described above may include the first member and the second member being different in (a) shape, (b) positional relationship relative to the nozzle placement surface, or (c) number. In a specific example of (a) described above, the surfaces of the first member and the second member facing the nozzle placement surface are different from each other in shape (e.g., one surface is smooth and the other surface is rough), contact area, or contact width. In a specific example of (b) described above, the first member is located in the main scanning direction with respect to the nozzle placement surface and the second member is located in the subscanning direction with respect to the nozzle placement surface, or the first member is located in the subscanning direction and the second member is located in the main scanning direction, or the first member and the second member have different tilt angles with respect to the nozzle placement surface. In a specific example of (c) described above, the structure includes, for example, multiple first members for a single treatment liquid head and a single second member for a single ink head.

Examples of (2) described above may include the first member and the second member being different in (d) manner of cleaning (e) cleaning direction, (f) cleaning pressure or cleaning speed, or (g) number of cleaning times. In a specific example of (d) described above, the first member and the second member clean in different manners selected from, for example, wiping the nozzle placement surfaces, applying a fluid such as compressed air, an inert gas, or a liquid to the nozzle placement surfaces, or transferring, adsorbing, or sucking contaminants on the nozzle placement surfaces. For example, the liquid may be water or another liquid, and the nozzle placement surfaces may be supplied with the liquid sprayed from a predetermined supply port or seeping out from a permeable component. In a specific example of (e) described above, the first member and the second member that are, for example, wiping the nozzle placement surfaces move in different directions selected from options including the main scanning direction, the subscanning direction, a diagonal direction, and a nozzle arrangement direction. In an example of (f) described above, the first member and the second member are pressed against the nozzle placement surfaces with different pressures, the first member and the second member are in or not in contact with the nozzle placement surfaces, or one of the first member and the second member cleans faster than the other of the first member and the second member. In an example of (g) described above, the first member and the second member clean the nozzle placement surfaces different numbers of times. For example, the treatment liquid head may be cleaned by the reciprocating first member (cleaned twice), and the ink heads may be cleaned by the outgoing second member or the returning second member (cleaned once).

Examples of (3) described above include the first member and the second member being different in absorbency, water repellency, strength such as rigidity or hardness, elastic modulus, electrical characteristics such as conductivity or capacitance. The first member and the second member having different characteristics described above are not limited to be made of different materials, and may be made of the same or similar materials.

The examples of (1) to (3) may be combined as appropriate to achieve the first member and the second member that are “different.”

Instead of in the embodiments described above, members that are “different” in structure, material, cleaning method, or characteristic described above may be used for ink heads for different colors or treatment liquid heads for different treatment liquids. For example, members that are different in structure, material, cleaning method, or characteristic may be used for a black ink head 4 and ink heads 4 for colors other than black, or for the pretreatment head 5 and the post-treatment head 6. In this case, the member that cleans the nozzle placement surface of the black ink head 4 may be different from the members that clean the nozzle placement surfaces of the ink heads 4 for colors other than black. The member that cleans the nozzle placement surface of the pretreatment head 5 may also be different from the member that cleans the nozzle placement surface of the post-treatment head 6. In this case, the examples in (1) to (3) described above may be combined as appropriate to achieve “different” members.

In the above embodiments, the ink heads 4 are cleaned with the blade BL and the fabric sheet FS. Instead of wiping multiple times with the same wiping member, “different” wiping members may be used for wiping multiple times in various combinations of wiping members.

The combination of the first member and the second member may be selected as appropriate. More specifically, the combination of the first member and the second member is not limited to a blade and a fabric sheet, a nonabsorbent wiper and an absorbent wiper, or a solid wiper and a porous wiper. For example, when the second member is a fabric sheet, an absorbent wiper, or a solid wiper, the first member that is appropriate in the structure, material, cleaning method, or characteristics described in the examples of (1) to (3) above can be selected for combination.

### REFERENCE SIGNS

1 inkjet printer
12 printing area
13 blade wipe area (one side portion)
14 fabric wipe area (other side portion)
3 carriage (head unit)
33 controller
4 ink head
40 nozzle placement surface
5 pretreatment head (treatment liquid head)
6 post-treatment head (treatment liquid head)
7 blade wipe device (first device)
70 blade wiper
72 ink blade (blade)
73 pretreatment liquid blade (blade)
74 post-treatment liquid blade (blade)
8 fabric wipe device (second device)
80 fabric wiper
BL blade
FS fabric sheet
W workpiece (recording medium)

1. An inkjet printer, comprising:
a treatment liquid head configured to eject a treatment liquid;
an ink head configured to eject ink;
a first member configured to clean a nozzle placement surface of the treatment liquid head; and
a second member configured to clean a nozzle placement surface of the ink head, the second member being different from the first member in structure, material, cleaning method, or characteristic.

2. The inkjet printer according to claim 1, wherein
the second member is a fabric sheet.

3. The inkjet printer according to claim 1, wherein
the second member is an absorbent wiper.

4. The inkjet printer according to claim 1, wherein
the second member is a porous wiper.

5. The inkjet printer according to claim 1, further comprising:
a first device including the first member;
a second device including the second member; and
a controller configured to control the first device and the second device,
wherein the controller is configured to control the first device and the second device to clean the nozzle placement surface of the ink head and the first device to clean the nozzle placement surface of the treatment liquid head.

6. The inkjet printer according to claim 5, wherein
the controller is configured to perform control of causing the first device to clean the nozzle placement surface of the ink head and then the second device to clean the nozzle placement surface of the ink head.

7. The inkjet printer according to claim 6, wherein
the controller is further configured to control ejection of ink from the ink head, and the controller is configured to cause the ink head to be purged to forcibly eject ink before causing the first device and the second device to perform cleaning in sequence.

8. The inkjet printer according to claim 1, further comprising:
a carriage receiving the treatment liquid head and the ink head;
a printing area in which a recording medium for inkjet printing is transported and the carriage reciprocates in a width direction perpendicular to a transport direction of the recording medium for an inkjet printing process;
a first device including the first member; and
a second device including the second member,
wherein the first device is located in one side portion of the printing area, and the second device is located in another side portion of the printing area.

9. The inkjet printer according to claim 1, further comprising:
a carriage receiving the treatment liquid head and the ink head;
a printing area in which a recording medium for inkjet printing is transported and the carriage reciprocates in a width direction perpendicular to a transport direction of the recording medium for an inkjet printing process;
a first device including the first member; and
a second device including the second member,
wherein the first device and the second device are arranged in one side portion of the printing area.

10. A method for cleaning a head unit including a treatment liquid head for ejecting a treatment liquid and an ink head for ejecting ink, the method comprising:
cleaning a nozzle placement surface of the treatment liquid head with a first member; and
cleaning a nozzle placement surface of the ink head with a second member, the second member being different from the first member in structure, material, cleaning method, or characteristic.

11. The method according to claim 10, wherein
the second member is a fabric sheet.

12. The method according to claim 10 wherein
the nozzle placement surface of the treatment liquid head is cleaned with the first member, and
the nozzle placement surface of the ink head is cleaned in two stages with the first member and then with the second member.

13. The method according to claim 12, wherein
cleaning the ink head with the first member includes
cleaning without the first member in contact with the nozzle placement surface, and
cleaning with the first member in contact with the nozzle placement surface.

14. The method according to claim 12, wherein
cleaning the ink head with the first member includes
cleaning without the first member in contact with the nozzle placement surface, and
cleaning with the first member in contact with the nozzle placement surface after the cleaning without the first member in contact with the nozzle placement surface, and
cleaning with a fabric sheet as the second member is performed after the cleaning with the first member in contact with the nozzle placement surface.

15. The method according to claim 14, wherein the ink head is purged to forcibly eject ink before the cleaning without the first member in contact with the nozzle placement surface.
